(19) United States
(12) Patent Application Publication
(10) Pub. No.: US 2004/0250011 A1
(43) Pub. Date: Dec. 9, 2004

(54) Storage device capable of increasing transmission speed

(75) Inventors: Chia-Li Chen, Hsindien City (TW); Hsiang-An Hsieh, Hsindien City (TW)

Correspondence Address: TROXELL LAW OFFICE PLLC, SUITE 1404, 5205 LEESBURG PIKE, FALLS CHURCH, VA, 22041, US

(73) Assignee: Carry Computer Eng. Co., Ltd.

(21) Appl. No.: 10/685,510

(22) Filed: Oct. 16, 2003

(30) Foreign Application Priority Data
Jun. 5, 2003 (TW) 092115321

(51) Int. Cl. G06F 12/00

(52) U.S. Cl. 711/103; 711/170; 711/118

(57) ABSTRACT

The present invention provides a storage device capable of increasing transmission speed, comprising at least a controller and at least a solid state storage medium; wherein said controller has at least an internal system interface that may be connected to an external system end, a microprocessor that processes system instructions, and a memory interface communicates with said solid-state storage medium; a data compression module is devised between said system interface and said memory interface and is used to compress the raw data transferred from the system interface into compressed data; said data compression module is equipped with multi-tiered front-end data caches and rear-end data caches between the system interface and the memory interface; said front-end data caches and rear-end data caches are arranged as caches to store raw data transferred from the system interface and compressed data to be transferred to the memory interface, in order to implement parallel operation among raw data transmission, compression of raw data stored in the caches, and transmission of compressed data so as to increase significantly the data transmission speed of said storage device.

### FIELD OF THE INVENTION

The present invention relates to a storage device capable of increasing transmission speed, in particular to a storage device that utilizes multi-tiered data caches to implement data compression to increase transmission speed.

### RELATED ART OF THE INVENTION

Currently, silicon solid-state storage media (e.g., Flash Memory) become popular. Due to their benefits such as low power consumption, high reliability, high storage capacity, and high access speed, they are widely used in mini memory cards (e.g., CF cards, MS cards, SD cards, MMC cards, SM cards, etc.) and USB U-disks.

Such a storage device usually comprises a controller and one or more solid-state storage media. Please see FIG. 1, the circuit diagram of such a storage device. Wherein the storage device A has an internal solid-state storage medium A2 and a controller A1; said controller A1 has an internal system interface A11 that may be connected to an external system end B, a microprocessor A12 that processes system instructions, and a memory interface A13 that communicates with said solid-state storage medium A2. Said controller may write the data from the system end B into said solid-state storage medium A2 or retrieves the data stored in said solid-state storage medium A2. In addition, a data cache A14 is devised between the system interface A11 and the memory interface A13 in consideration of the difference in data transmission speed between the external system end B and the storage device A. Due to the fact that the data processing speed of the external system end B e.g., a PC is much higher than that of the storage device A, to process the data transferred from the system end B, a cache space shall be devised in the storage device A in order to avoid degrade the performance of the system end B. However, because the data cache A14 is mainly used to store data temporarily, duplex operation (i.e. I/O operations in parallel) is impossible. That is to say, for example, when the data cache A14 is receiving data transferred from the system interface A11, any data output from it has to be stopped. Therefore, at that moment, the data can't be stored in said solid-state storage medium A2 via the memory interface.

Please see FIG. 2A˜2C, wherein above problem is described further.

FIG. 2A shows that the system interface A11 stores the first batch of data into the data cache A14 in the first time period; FIG. 2B shows the first batch of data stored in the data cache A14 is transferred to the memory interface A13 in the second time period. During the second time period, data transmission from the system end B shall be paused because that the data cache A14 is unable to receive data for the moment. Only when the data stored in the data cache A14 is cleared, the second batch of data from the system end can be received, as shown in FIG. 2C. However, during the current time period (i.e., the third time period), because that the data cache A14 is receiving data and can't carry out data output, the memory interface A13 has to be “Idle”, and the data storing operation of the solid-state storage medium A2 is also paused.

Because that the data cache A14 doesn't support parallel I/O operations, it is impossible for the storage device A to carry out data access continuously, and the external system end B can't write or retrieve data uninterruptedly. That problem not only degrades the data access speed of the storage device A but also increase data processing delay at the system end B.

Therefore, it is favorable to provide a storage device that supports duplex operation (parallel I/O operations) of the data cache. Such a storage device may significantly improve the overall performance of the system end and the storage device.

Further, it is also favorable to provide a storage device with a enhance controller, i.e., the controller may utilize an appropriate compression mechanism to compress the data transferred from the system end to decrease data transmission volume. Combined with the design of duplex data cache, such a storage device may further shorten data transmission duration and increase data access speed.

### DESCRIPTION OF THE INVENTION

The main purpose of the invention is to provide a storage device capable of increasing transmission speed and supporting parallel I/O operations of data caches with the multi-tiered cache design, in order to enable to external system end to perform data access continuously to significantly increase the transmission speed of the storage device.

Another purpose of the invention is to provide a storage device capable of increasing transmission speed; said storage device may significantly reduce the data volume of the external data through its internal compression mechanism to shorten the time period necessary for data transmission. In that way, the overall access speed of the storage device will be increased. Furthermore, under the help of the compression mechanism, the solid-state storage medium in the storage device may store more data; in other words, the cost of the product is decreased. Another purpose of the invention is to combine the storage device capable of increasing transmission speed with above improved data cache and the compression mechanism to improve overall performance of the storage device in multi times.

To attain above and other purposes and efficacies, the storage device capable of increasing transmission speed described in the present invention comprises a controller and at least a solid-state storage medium. Said controller has an internal system interface that may be connected to an external system end, a microprocessor that processes system instructions, and a memory interfaces that communicates with said solid-state storage medium, wherein a multi-tiered data cache unit is devised between said system interface and said memory interface. The first tier of data cache and the next tier of data cache perform data transmission alternatively to increase the internal transmission speed of the storage device so that the external system end may write or read data continuously without any delay.

Another purpose of the invention is to provide a storage device capable of increasing transmission speed, wherein said storage device is equipped with a data compression/decompression module on the basis of above original structure. Said data compression/decompression module is triggered by the microprocessor to compress the raw data transferred from the system interface at a preset ratio into corresponding minimized compressed data, in order to increase the internal transmission speed of the storage device.

To understand above and other purposes, features, and benefits of the invention better, the invention is described in the following embodiments, with reference to the attached drawings.

### DETAILED DESCRIPTION OF THE EMBODIMENTS

Please see FIG. 3, a sketch map of the internal circuit of the storage device capable of increasing transmission speed described in the present invention, wherein the storage device 1 may be a memory card that is widely used in various portable digital products or a USB U-disk that is used in PCs, or any storage device with solid-state storage media (i.e., Flash Memory) under development.

Wherein said storage device 1 mainly comprises a controller 10 and at least a solid-state storage medium 20; said controller 10 comprises an internal system interface 1040, a microprocessor 102, and a memory interface 106. Said system interface 104 is used to connect an external system end 2 (i.e., any above portable digital product or PC); said memory interface 106 communicates with said solid-state storage medium 20; said microprocessor 102 is connected to said system interface 104 and said memory interface 106.

A plurality of tiers of data caches is devised between said system interface 104 and said memory interface 106. In the present embodiment, two tiers of data caches 112 are devised: the first tier of data cache 110 and the second tier of data cache 112 (it is noted that the present invention is not limited to two tires of data caches. “Two tiers of data caches” is the minimum quantity required to achieve the purpose of increasing transmission speed. Of cause, depending on the requirement for transmission speed, more tiers of data caches may be added to further increase the internal transmission speed of the storage device 1). Said first tier of data cache 110 and second tier of data cache 112 perform data transmission between the system interface 104 and the memory interface 106 alternatively, which is detailed as follows.

Please see FIG. 4A˜4C, wherein when the external system end request to write data into the storage device 1 continuously, the first batch of data transferred from the system end 2 is loaded into the first data cache 110 via the system interface 104, as shown in FIG. 4A. When the first data cache 110 receives the first batch of data, it stops the data receiving process, and the second data cache 112 begins to receive the second batch of data transferred from the system end 2, as shown in FIG. 4B. At the same time, the first data cache 110 begins to transfer the data stored in it to the solid-state storage medium 20 via the memory interface 106. When the data is transferred to the memory interface 106, the microprocessor 102 clears the first data cache 110 and instructs it to receive the third batch of data from the system end, as shown in FIG. 4C. At that time, the second data cache 112 begins to store the data stored in it into the solid-state storage medium 20 via the memory interface 106. Through the alternative operation process, the internal transmission speed of the storage device 1 is increased and the external system end 2 may write data into said storage device 1 continuously without delay. On the other hand, the external system end 2 may also read data from said storage device 1 in similar way.

Please see FIG. 5, another design for increasing data transmission speed, wherein a data compression/decompression module is devised in the storage device 1. Said data compression/decompression module is wired to said microprocessor 102 and is triggered under the control of the microprocessor 102. There is the first data cache 124 and the second data cache 126 between the system interface 104 and the data compression/decompression module 108 as well as the data compression/decompression module 108 and the memory interface 106, respectively. Said data caches 124 and 126 are used to store data temporarily. But they store different types of data.

When external data is to be stored into the solid-state storage medium 20 in the storage device 1, the system interface 104 receives raw data from the system end 2, and said microprocessor 102 instructs the data compression/decompression module 108 to compress the raw data at an appropriate compression ratio (e.g., 1/N, wherein “N” depends on the compression algorithm used and may be 2, 3, 4, . . . ) into compressed data, and then stores the compressed data into the solid-state storage medium 20 via the memory interface 106. Due to the fact that compressed data consumes less time in transmission than the corresponding raw data does, the data transmission speed between the data compression/decompression module 108 and the memory interface as well as the data access speed between the memory interface 106 and the solid-state storage medium 20 are increased.

In the design of the present embodiment, before transferring raw data for compression, the system interface 104 stores the raw data in the first data cache 124. Then, the data compression/decompression module 108 retrieves data stored in the first data cache 124 at a certain transmission speed and compresses it, and then transfers the compressed data into the second data cache 126. Finally, under the control of the microprocessor 102, the compressed data stored in the second data cache 126 is stored in the solid-state storage medium 20 via the memory interface 106.

When the system end 2 request to retrieve data from the solid-state storage medium 20 in the storage device 1, the memory interface 106 retrieves the data from the solid-state storage medium 20 and store it in the second data cache 126, then the data compression/decompression module 108 reads the data from the second data cache 126 and decompresses it, and then stores the decompressed data into the first data cache 124. Finally, the system interface 104 retrieves the decompressed data from the first data cache 124 and then transfers it to the system end 2.

Please see FIG. 6, another embodiment of the invention, wherein the embodiment combines above tiered data cache structure and the compression mechanism. A data compression/decompression module 108 is devised between the system interface 104 and the memory interface 106 in the storage device 1. There is a tiered data cache area (first system-end data cache 132 and second system-end data cache 134, collectively referred as “front-end data caches”) between said data compression/decompression module 108 and said system interface 104; in addition, there is also a tiered data cache area (first memory data cache 136 and second memory data cache 138, collectively referred as “rear-end data caches”) between said data compression/decompression module 108 and said memory interface 106.

When the external system end 2 request to write data into the storage device 1 continuously, said data compression/decompression module 108 is triggered by the microprocessor 102 to compress the raw data transferred from the system interface 104 at a preset compression ratio into reduced volume, in order to increase the data transmission speed in the storage device 1; before the data compression/decompression module 108 compresses the raw data, the first system-end data cache 132 and the second system-end data cache 134 receive and transfer the raw data alternatively, i.e., when the first system-end data cache 132 receives raw data transferred from the system end 104, the second system-end data cache 134 transfers the received raw data to the data compression/decompression module 134 for compression. Thus the system interface 104 and the data compression/decompression module 108 perform data transmission, receiving, and compression operations simultaneously.

When the data compression/decompression module 108 finishes data compression operation, the first memory data cache 136 and the second memory data cache 138 perform data receiving and transfer alternatively. The difference between the front-end data caches and the rear-end data caches is that the front-end data caches are used to store raw data, while the rear-end data caches are used to store compressed data. Please see FIG. 7A˜7D, wherein the compression operation on the basis of the circuit distribution shown in FIG. 6 is detailed. The storage capacity of the rear-end data caches may be equal to that of the front-end data caches or different to that of the front-end data caches according to the compression ratio. In the present embodiment, the storage capacity of those data caches is irrelevant to the compression ratio, i.e., the data compression/decompression module 108 compress the raw data at ½ compression ratio, but the storage capacity of the rear-end data caches is fixed (equal to that of the front-end data caches).

Please see FIG. 7A, wherein when the system end writes data in the storage device continuously, the first batch of data transferred from the system end is loaded into the first system-end data cache 132; when the first batch of data is loaded, the microprocessor 102 instructs the second system-end data cache 134 to receive the second batch of raw data, as shown in FIG. 7B. At the same time, microprocessor 102 instructs the data compression/decompression module 108 to receive the first batch of raw data transferred from the first system-end data cache 132 and compresses the data, and then writes the compressed data into the first memory data cache 136.

Please see FIG. 7C, wherein after the first system-end data cache 132 transfers the data in it to the data compression/decompression module 108, the microprocessor 102 clears the first system-end data cache 132 and instructs it to receive the third batch of data from the system end. At that time, the microprocessor 102 also instructs the data compression/decompression module 108 to receive the second batch of data transferred from the second system-end data cache 134, compresses it, and then writes the compressed data into the first memory data cache 136. As shown in FIG. 7D, when above data is transferred, the first memory data cache 136 is full first batch and second batch of data, and then the first batch and second batch are written into the solid-state storage medium 20 via the memory interface 106. At the same time, the first system-end data cache 132 transfers the third batch of data to the second memory data cache 138 via the data compression/decompression module 108, and the second system-end data cache 134 may be cleared and begins to receive the next batch of data from the system end.

The design of the tiered-data cache structure ensures the storage device 1 to perform data transmission from system interface, compression of data stored in the system-end data caches, and transmission of the compressed data via the memory interface in parallel and continuously, increasing significantly the data transmission speed of the storage device.

Above data compression/decompression module 108 may be implemented with hardware or firmware and may be embedded in the controller 10 or separated from the controller 10.

In conclusion, the present invention is disclosed as above with preferred embodiments. However, it is noted that above embodiments shall not constitute any limitation to the invention. Any person familiar with the technologies may carry out modifications or embellishments to the embodiments without deviating from the concept and scope of the invention. Therefore, the scope of the invention is solely defined with the attached claims. Any embodiment implemented with equivalent modifications or embellishments to the invention shall fall in the scope of the invention.

### BRIEF DESCRIPTION OF THE DRAWINGS

FIG. 1 is a sketch map of the circuit of a traditional storage device.

FIG. 2A˜2C show the operation flow of the storage device in FIG. 1.

FIG. 3 is a sketch map of the circuit of a preferred embodiment of the storage device described in the present invention.

FIG. 4A˜4C shows the operation flow of the storage device in FIG. 3.

FIG. 5 is a sketch map of the circuit of another preferred embodiment of the storage device described in the present invention.

FIG. 6 is a sketch map of the circuit of another preferred embodiment of the storage device described in the present invention.

FIG. 7A˜7D show the operation flow of the storage device in FIG. 6.

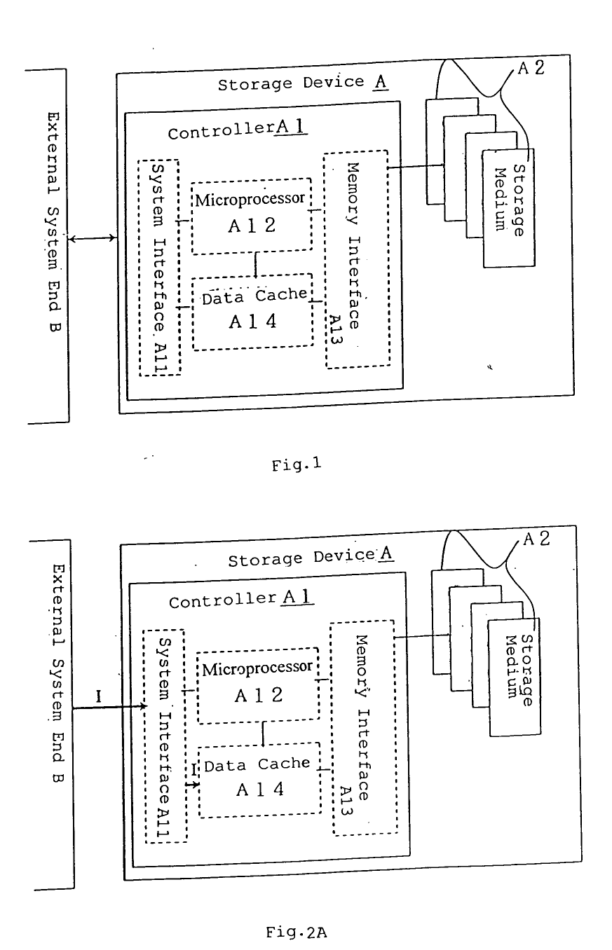

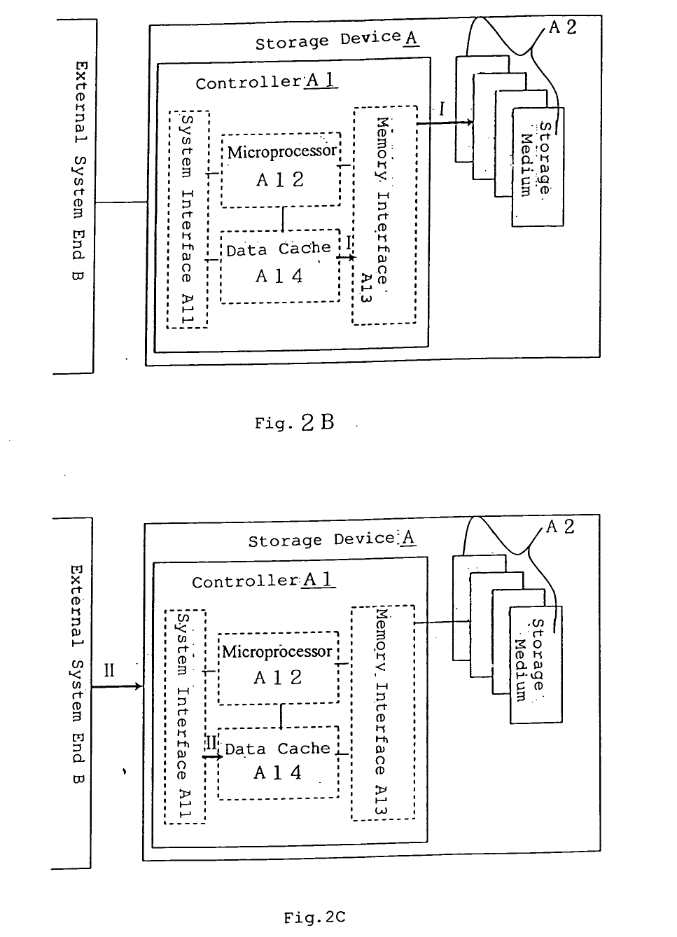

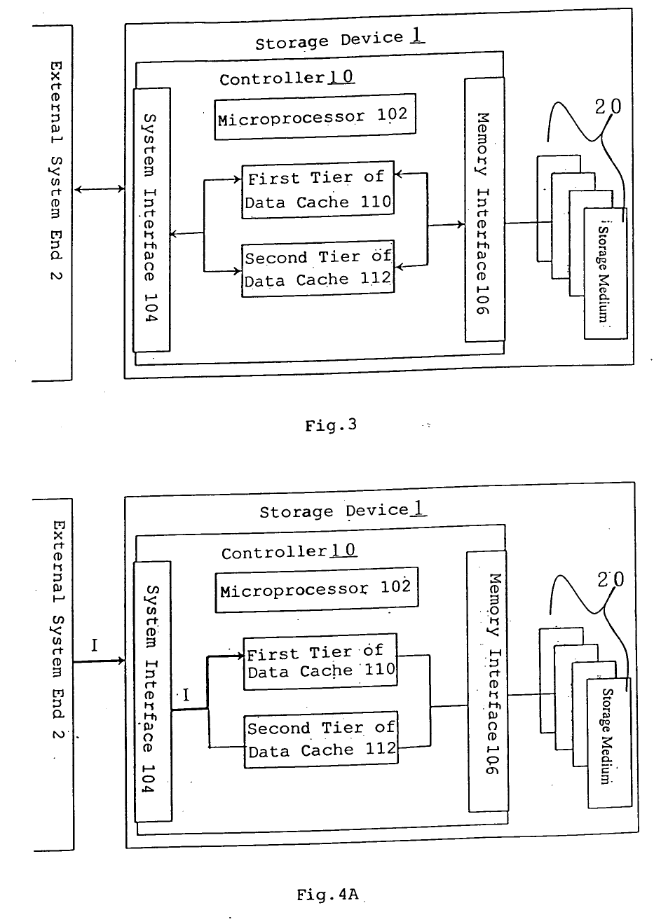

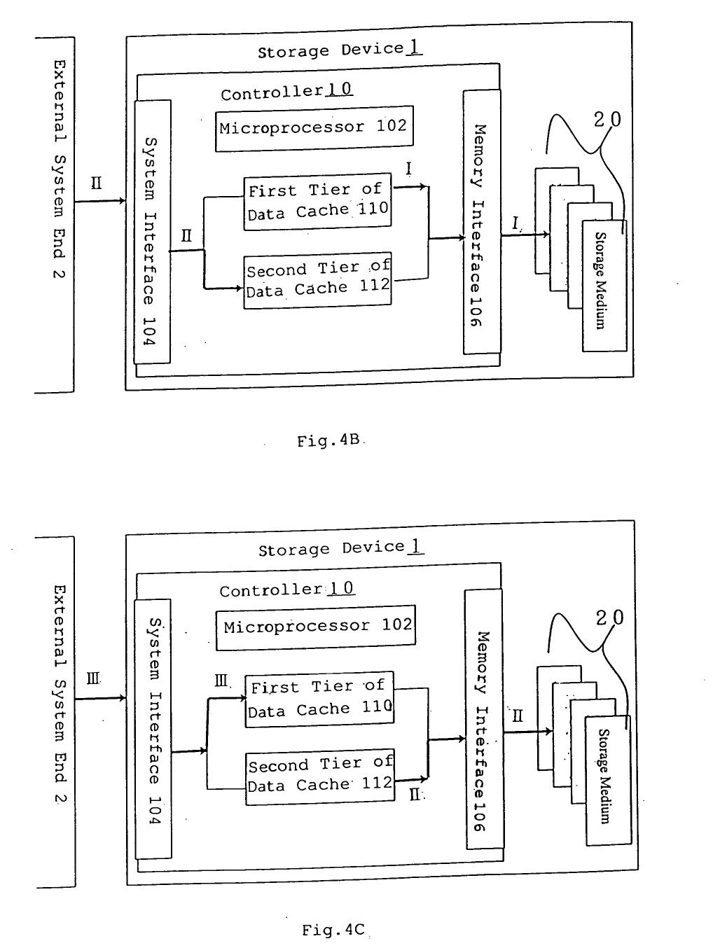

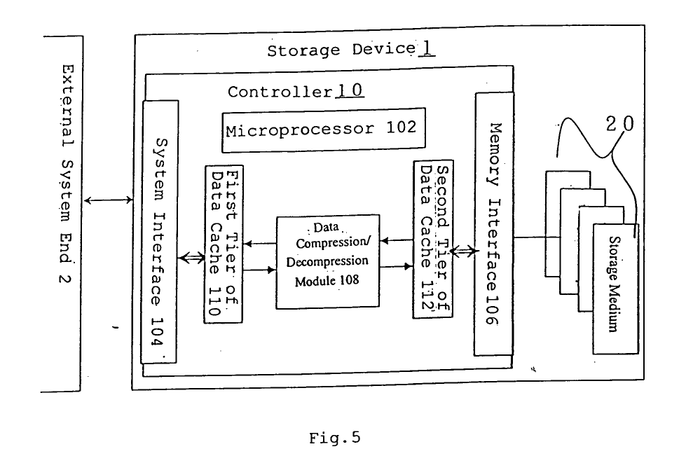

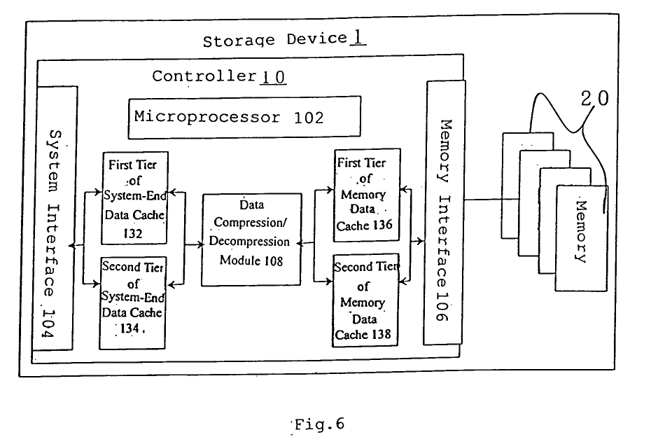

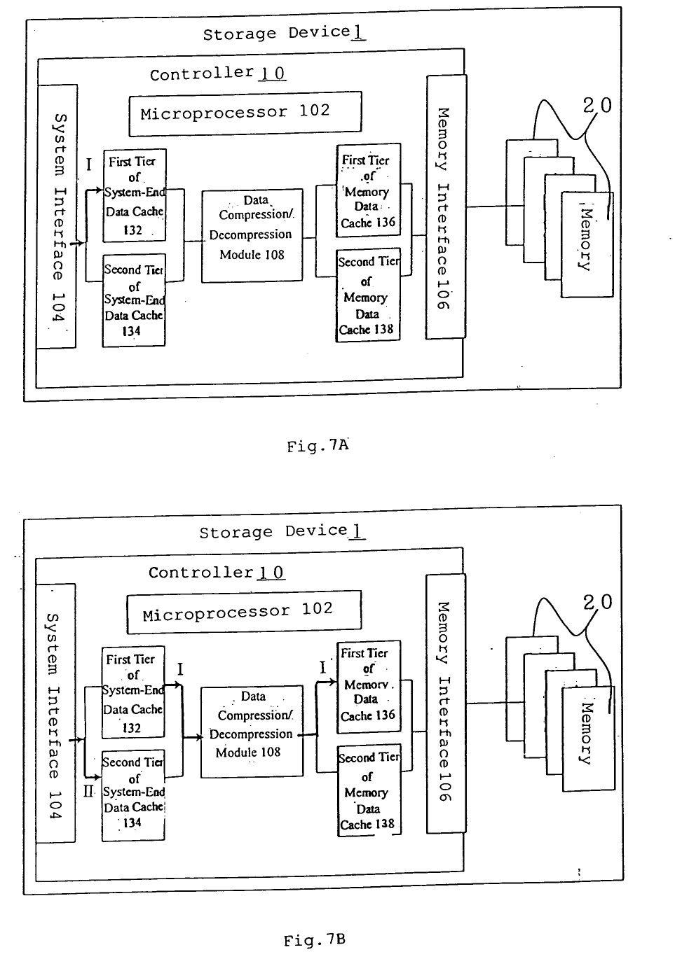

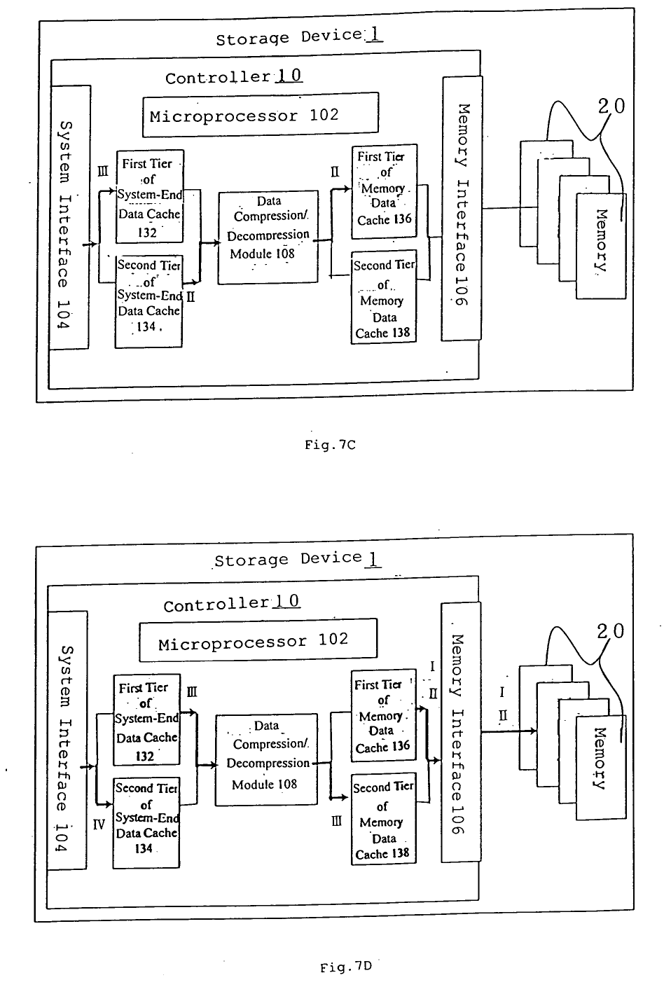

### DESCRIPTION OF THE SYMBOLS

A: Storage Device

A1: Controller

A11: System Interface

A12: Microprocessor

A13: Memory Interface

A14: Data Cache

A2: Solid-State Storage Medium

B: External System End

1: Storage Device

10: Controller

104: System Interface

102: Microprocessor

106: Memory Interface

108: Data Compression/Decompression Module

110: First Tier of Data Cache

112: Second Tier of Data Cache

124: First Data Cache

126: Second Data Cache

132: First System-End Data Cache

134: Second System-End Data Cache

136: First Memory Data Cache

138: Second Memory Data Cache

20: Solid-State Storage Medium

2: External System End

What is claimed is:

1. A storage device capable of increasing transmission speed, comprising a controller and at least a solid-state storage medium; said controller has an internal system interface that may be connected to an external system end, a microprocessor that processes system instructions, and a memory interface that communicates with said solid-state storage medium; wherein said storage device is featured with: a plurality of data caches is devised between said system interface and said memory interface; said data caches are designed in tiers, wherein the first tier of data cache and the second tier of data cache perform data receiving and transfer alternatively to implement parallel data transmission between said system interface and said memory interface.

2. A storage device capable of increasing transmission speed, mainly comprising a controller and at least a solid-state storage medium; said controller has an internal system interface that may be connected to an external system end, a microprocessor that processes system instructions, and a memory interface that communicates with said solid-state storage medium; wherein said storage device is featured with: a data compression/decompression module with a data compression mechanism is devised in said storage device and is designed to compress the raw data transferred via the system interface at an appropriate compression ratio into compressed data, in order to increase data access speed.

3. The storage device capable of increasing transmission speed as in claim 2, wherein said data compression/decompression module has an internal decompression mechanism, which is triggered by the microprocessor to decompress the compressed data stored in said solid-state storage medium into original raw data and transfer to the system end.

4. The storage device capable of increasing transmission speed as in claim 2, wherein said storage device has the first data cache, which is wired to said system interface, microprocessor, and data compression/decompression module.

5. The storage device capable of increasing transmission speed as in claim 2, wherein said controller has the second data caches, which is wired to said memory interface, microprocessor, and data compression/decompression module.

6. The storage device capable of increasing transmission speed as in claim 2, wherein said data compression/decompression module is embedded in said controller and between said system interface and said memory interface.

7. A storage device capable of increasing transmission speed, mainly comprising a controller and at least a solid-state storage medium; said controller has an internal system interface that may be connected to an external system end, a microprocessor that processes system instructions, and a memory interface that communicates with said solid-state storage medium; wherein said storage device is featured with:
a data compression/decompression module is devised between said system interface and said memory interface and is used to compress the raw data transferred via said system interface into compressed data to increase the data transmission speed in said storage device;
a front-end data cache area comprising multi-tiered system-end data caches is devised between said data compression module and said system interface and is designed into a multi-tiered structure; wherein every tier of system-end data cache and its next tier of system-end data cache receive and transfer data alternatively in parallel to implement parallel raw data transmission between said data compression/decompression module and said system interface;
a rear-end data cache area comprising multi-tiered memory data caches is devised between said data compression module and said memory interface and is designed into a multi-tiered structure; wherein every tier of memory data cache and its next tier of memory data cache receive and transfer data alternatively in parallel to implement parallel compression data transmission between said data compression/decompression module and said memory interface.

8. The storage device capable of increasing transmission speed as in claim 7, wherein said data compression/decompression module has a decompression mechanism, which is triggered by the microprocessor to decompress the compressed data in the solid-state storage medium into original raw data and transfer the raw data to the external system end.

9. The storage device capable of increasing transmission speed as in claim 7 or 8, wherein said data compression/decompression module is embedded in said controller.

10. The storage device capable of increasing transmission speed as in claim 7, wherein the storage capacity of said rear-end data caches is equal to that of the front-end data caches.

11. The storage device capable of increasing transmission speed as in claim 7, wherein said the storage capacity of said rear-end data caches may be smaller than that of the front-end data caches according to the compression ratio.
